(19) United States
(12) Patent Application Publication
(10) Pub. No.: US 2008/0101338 A1
(43) Pub. Date: May 1, 2008

(54) METHODS AND APPARATUS TO IMPLEMENT HIGHER DATA RATE VOICE OVER INTERNET PROTOCOL (VoIP) SERVICES

(76) Inventors: Douglas F. Reynolds, Austin, TX (US); Miles Torbett Pierce, Austin, TX (US); Marc Andrew Sullivan, Austin, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/555,546

(22) Filed: Nov. 1, 2006

(51) Int. Cl. H04L 12/66

(52) U.S. Cl. 370/352

(57) ABSTRACT

Methods and apparatus to implement higher data rate voice over Internet protocol (VoIP) services are disclosed. An example method comprises retrieving a data rate capability associated with a destination of a voice over Internet protocol (VoIP) session from a customer database, selecting between a first codec having a first bit rate and a second codec having a second bit rate different from the first bit rate based on the retrieved data rate capability, and establishing the VoIP session based on a selected one of the first and second codecs.

### FIELD OF THE DISCLOSURE

This disclosure relates generally to voice over Internet protocol (VoIP) services and, more particularly, to methods and apparatus to implement higher data rate VoIP services.

### BACKGROUND

New communication technologies, such as voice over Internet Protocol (VoIP), are affecting the communication industry. Due to technical feasibility and/or economic constraints, many existing and/or new technologies limit the amount of bandwidth allocated to particular communication services and/or communication sessions. However, history and research have shown that people, if given the choice, prefer the higher fidelity and/or higher quality audio and/or video to allow greater conveyance of conversational and/or situational cues.

### BRIEF DESCRIPTION OF THE DRAWINGS

FIG. 1 is a schematic illustration of an example voice over Internet protocol (VoIP) communication system constructed in accordance with the teachings of the invention.

FIG. 2 illustrates an example manner of implementing any or all of the example VoIP devices of FIG. 1.

FIG. 3 illustrates an example manner of implementing the example call processing system of FIG. 1.

FIG. 4 illustrates an example manner of implementing any or all of the example monitor modules of FIGS. 1, 2 and/or 3.

FIG. 5 illustrates an example data structure that may be used to implement the example profile database of FIG. 1.

FIG. 6 is a diagrammatic illustration of an example behavior of the example communication system of FIG. 1.

FIG. 7 illustrates an example data structure that may be used to convey codec negotiation information.

FIG. 8 is a flowchart representative of example machine readable instructions which may be executed to implement any or all of the example VoIP devices of FIGS. 1 and/or 2, and/or the example call processing system of FIGS. 1 and/or 3.

FIG. 9 is a flowchart representative of example machine readable instructions which may be executed to implement any or all of the example monitor modules of FIGS. 1, 2 and/or 3

FIG. 10 is a schematic illustration of an example processor platform that may be used and/or programmed to execute the example machine readable instructions represented by FIGS. 8 and/or 9 to implement the example VoIP devices, the example call processing system and/or the example monitor modules described herein.

### DETAILED DESCRIPTION

Methods and apparatus to improve the quality of voice over Internet protocol (VoIP) services are disclosed. A disclosed example method comprises retrieving a data rate capability associated with a destination of a voice over Internet protocol (VoIP) session from a customer database, selecting between a first codec having a first bit rate and a second codec having a second bit rate different from the first bit rate based on the retrieved data rate capability, and establishing the VoIP session based on a selected one of the first and second codecs. A disclosed example apparatus for a VoIP network having a plurality of VoIP destinations comprises a memory to store a data structure, the data structure having a first portion representative of a first data rate capability for a first VoIP destination, and a second portion representative of a second data rate capability for a second VoIP destination, and a processor to select a codec for a VoIP session to the first VoIP destination based on the first data rate capability. Another disclosed example VoIP device comprises a network interface, and a VoIP processor to retrieve a data rate capability associated with a destination of a VoIP session from a VoIP network, and select between a first codec having a first bit rate and a second codec having a second bit rate different from the first bit rate based on the retrieved data rate capability.

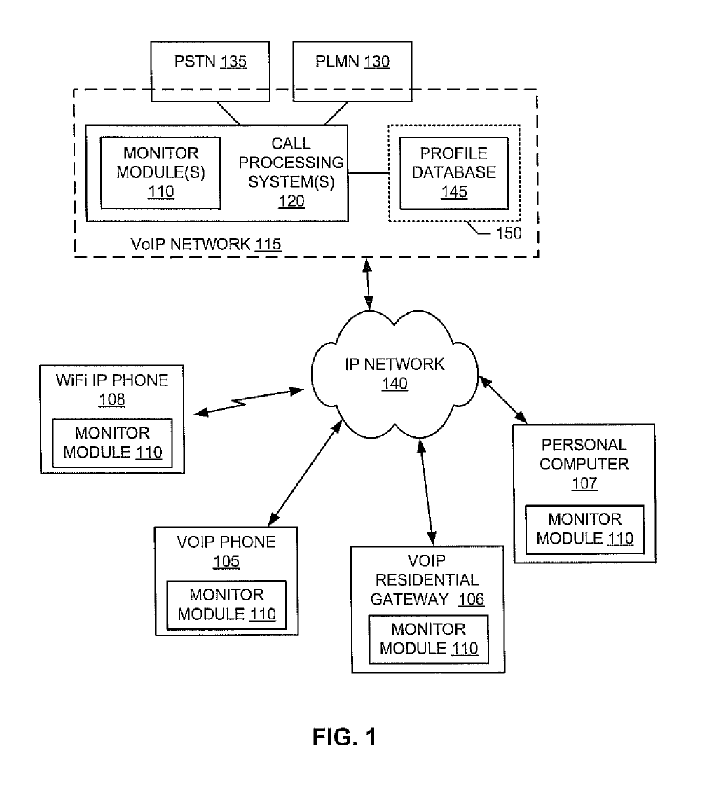

FIG. 1 is a schematic illustration of an example VoIP communication system constructed in accordance with the teachings of the invention. In the interest of brevity and clarity, throughout the following disclosure references will be made to enhanced and/or higher bit rate communication services for the example VoIP communication system of FIG. 1, VoIP networks, VoIP devices and/or VoIP services. However, it should be understood that the methods and apparatus to improve the quality of communication services disclosed herein are applicable to other types of communication services, networks, technologies and/or systems such as public switched telephone network (PSTN) systems, wireless distribution systems, wired or cable distribution systems, coaxial cable distribution systems, Ultra High Frequency (UHF)/Very High Frequency (VHF) radio frequency systems, satellite or other extra-terrestrial systems, cellular distribution systems, power-line broadcast systems, fiber optic networks, and/or combinations and/or hybrids of these devices, systems and/or networks.

Further, while disclosed examples discussed herein utilize session initiation protocol (SIP) exchanges, messages and/or techniques to initiate, establish and/or modify VoIP communication sessions, any number and/or type(s) of communication protocol(s), message(s), exchange(s) and/or technique(s) for initiating, establishing and/or modifying communication sessions may be utilized. For example, any past, current and/or future media gateway control protocol (MGCP) standard and/or specification such as the International Telecommunication Union (ITU) H.248 standard may be employed.

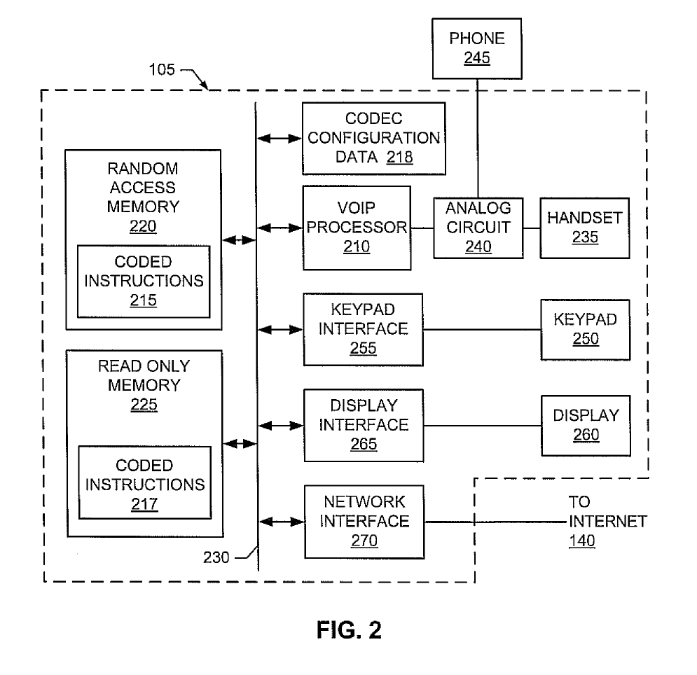

To allow users to, for example, place and/or receive a VoIP based communication service, such as a telephone call, the example communication system of FIG. 1 includes one or more VoIP devices, four of which are illustrated in FIG. 1 with reference numerals 105, 106, 107 and 108. The example VoIP devices 105, 106, 107 and 108 may be any type(s) of VoIP devices including, for example, a corded and/or cordless VoIP phone 105, a VoIP residential gateway 106, a VoIP enabled personal computer 107, a VoIP endpoint, a wireless VoIP device 108 (e.g., a wireless-fidelity (Wi-Fi) Internet protocol (IP) phone), or a VoIP adapter (e.g., analog telephone adapter (ATA)). An example manner of implementing any or all of the example VoIP devices 105, 106, 107 and 108 of FIG. 1 is discussed below in connection with FIG. 2.

As illustrated in FIG. 1, each of the example VoIP devices 105, 106, 107 and 108 includes a monitor module 110. The example monitor modules 110 of FIG. 1 may be configured to monitor the quality of a VoIP communication session by monitoring, for example, one or more of a bandwidth, a quality-of-service, a delay, a jitter, or a packet loss rate. If the quality of the session degrades (e.g., a value representative of the quality falls below a threshold), the example monitor modules 110 can initiate one or more of: (a) a new codec type, (b) a new encoding bit rate to be used, or (c) a change in the encoding bit rate for the codec type currently being employed for the VoIP communication session. In some examples, the monitor modules 110 can, additionally or alternatively, obtain information, such as a data rate capability of a destination endpoint, and then use such information when selecting a codec type and/or encoding bit rate for a VoIP session being initiated. An example manner of implementing the example monitor modules 110 of FIG. 1 is discussed below in connection with FIG. 4.

While the example VoIP devices 105-108 of FIG. 1 include monitor modules 110 that implement substantially similar functionality, a particular monitor module 110 implemented by any of the VoIP devices 105-108 may differ in any of a variety of ways from a monitor module 110 implemented by any other of the VoIP devices 105-108. For example, a first example monitor module 110 (e.g., implemented by the example PC 107) may be implemented as machine accessible instructions executed by a processor, while a second example monitor module 110 (e.g., implemented by the example VoIP phone 105) is implemented as any combination of firmware, hardware and/or logic. Further, one or more of the VoIP devices 105, 106, 105, 106, 107 and/or 108 need not include a monitor module 110. Moreover, the example monitor modules 110 may differ in the number and/or type(s) of features they implement and/or perform.

To provide VoIP communication services, the example system of FIG. 1 includes any number and/or type(s) of VoIP communication networks 115. To initiate, receive, establish, complete and/or route any type(s) of VoIP communication sessions and/or VoIP telephone calls with, to and/or between the example VoIP devices 105, 106, 107 and/or 108, the example VoIP communication network 115 of FIG. 1 may communicate with and/or contain any portion of any number and/or type(s) of call processing system(s) 120. The call processing system(s) 120 and/or VoIP networks 115 may be operated by any number of service providers.

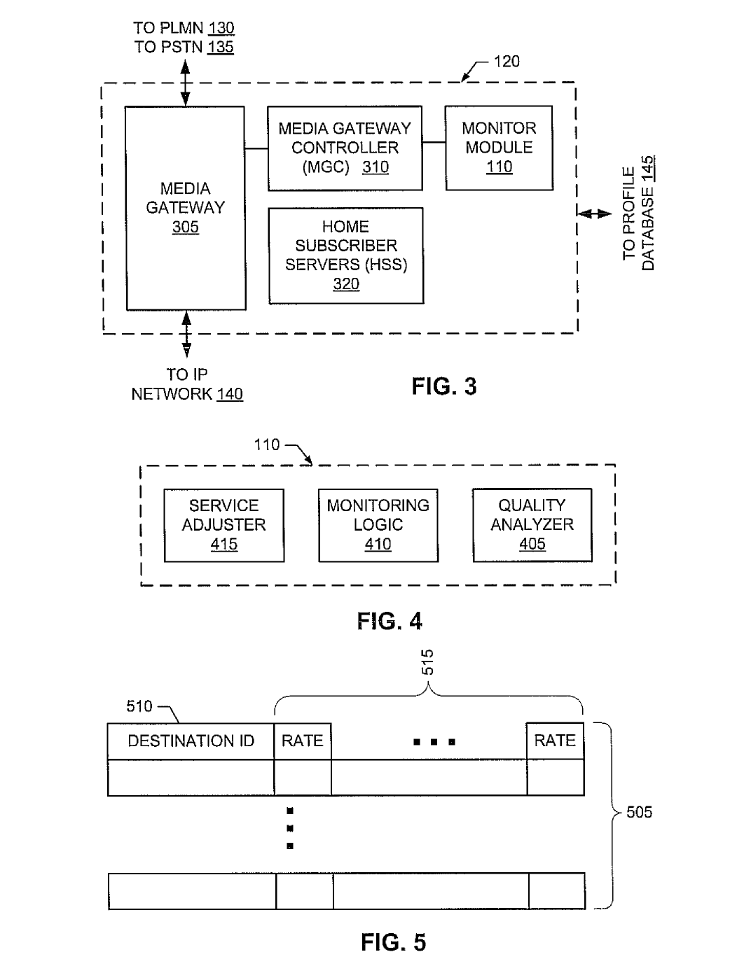

In the example communication system illustrated in FIG. 1, the call processing system(s) 120 are implemented using an architecture commonly referred to in the industry as a “soft-switch architecture.” However, any type(s) of call processing system architecture(s) may be implemented. For example, the call processing system(s) 120 may be implemented in accordance with a past, current and/or future 3^{rd} Generation Partnership Program (3GPP) Internet Multimedia Subsystem (IMS) standard, and/or may be implemented using, for example, session border controllers, call processors, call serving controllers, etc. An example manner of implementing the example call processing system(s) 120 of FIG. 1 is described below in connection with FIG. 3.

As illustrated in FIG. 1, the call processing system(s) 120 may include any number of monitor modules 110 to monitor one or more of a bandwidth, a quality-of-service, a delay, a jitter, or a packet loss rate for one or more ongoing communication sessions. If the quality of a particular session degrades (e.g., a value representative of the quality falls below a threshold), the corresponding monitor module 110 can initiate one or more of: a new codec type and encoding bit rate to be used for the VoIP communication session. An example manner of implementing the example monitor modules 110 of FIG. 1 is discussed below in connection with FIG. 4.

As illustrated in FIG. 1, the example VoIP communication network 115 may include an interface to and/or contain a portion of a public land mobile network (PLMN) 130 (i.e., a cellular communication network), an interface to and/or contain a portion of a PSTN 135, and/or an interface to and/or contain a portion of any number and/or type(s) of additional communication networks, such as an Internet Protocol (IP) network 140 (e.g., the Internet). For example, using any number and/or type(s) of technique(s), method(s), protocol(s) and/or technology(-ies), the call processing system(s) 120 and the PSTN 135 can facilitate telephone calls between a PSTN-based phone (not shown) and any of the example VoIP devices 105, 106, 107 and 108.

The example PLMN 130 and/or the example PSTN 135 of FIG. 1 may be implemented by any number and/or type(s) of communication devices, switches, protocols, systems and/or technologies. For instance, the example PLMN 130 may include any number of cellular base stations that can transmit cellular signals to and/or receive cellular signals from a cellular communication device (not shown) using any type(s) of protocols (e.g., time-division multiple access (TDMA), code-division multiple access (CDMA), orthogonal frequency-division multiple access (OFDM), etc.).

In the illustrated example of FIG. 1, the example VoIP devices 105, 106, 107 and 108 are communicatively coupled to the example VoIP communication network 115 via any number and/or type(s) of public and/or private IP networks 140 such as the Internet. However, any number and/or type(s) of past, current and/or future communication network(s), communication system(s), communication device(s), transmission medium(s), protocol(s), technique(s) and/or standard(s) could be used to couple the VoIP devices 105, 106, 107 and 108 to the VoIP communication network 115. Interfaces between the VoIP devices 105, 106, 107 and 108 and the IP network 140, and/or the VoIP communication network 115 and the IP network 140 may be implemented using any number and/or type(s) of past, current and/or future device(s), technology(-ies) and/or method(s). For example, the example VoIP devices 105, 106, 107 and/or 108 may be coupled to the IP network 140 via any type(s) of voice-band modem(s), digital subscriber line (DSL) modem(s), cable modem(s), Ethernet transceiver(s), optical transceiver(s), IP virtual private network (VPN) connection(s), Insititute of Electrical and Electronics Engineers (IEEE) 802.11x (a.k.a. WiFi) transceiver(s), IEEE 802.16 (a.k.a. WiMax), access point(s), etc. Moreover, the example IP network 140 of FIG. 1 may extend geographically to include a location near to and/or encompassing a VoIP device 105, 106, 107 and/or 108. For example, the IP network 140 may include a wireless access point (not shown) by which, for example, the example WiFi IP phone 108 connects to the IP network 140.

Because each of the example VoIP devices 105-108 may connect to the IP network 140 and/or the VoIP communications network 115 via different communication technologies, the bandwidth, bit rate and/or data rate of VoIP communication service data that can be exchanged between the VoIP devices 105-108 and the VoIP network 115 may be accordingly different. For example, a PC 107 and/or VoIP gateway 106 connected to the IP network 140 via a high-speed and/or broadband connection may be able to support high data rate communication services (e.g., VoIP telephone services using a codec encoding rate that is greater than 128 kilobits per second (kbps)), while a WiFi IP phone 108 may, on at least some occasions, only be able to support low data rate communication services (e.g., a VoIP telephone services using a codec encoding rate that is less than 64 kbps).

As described in more detail in connection with the illustrated example of FIG. 7, when a VoIP communication session is being initiated and/or established with one or more of the VoIP devices 105-108, the example call processing system 120 of FIG. 1 determines the data rate capability of the endpoints of the VoIP communication session (e.g., one of the VoIP devices 105-108). If the originator and/or the destination endpoints are currently connected to the IP network 140 such that one or both of them can support high data rate communication services (e.g., expanded VoIP telephone services implementing codec encoding bit rates of greater than 128 kbps), the example call processing system 120 initiates and/or facilitates the negotiation of a codec type and/or encoding bit rate commensurate with the high data rate capability of the endpoint(s). As such, when two VoIP endpoints of a VoIP communication session support high data rate communications, the call processing system 120 causes the VoIP communication session to be established at a new or higher data rate supported by the device in question, thereby improving the audio and/or video fidelity and/or quality of the ensuing VoIP communication session as compared to a session between the same two devices using a default data rate supported by even the lowest data rate end point of the system.

In the illustrated example, the call processing system 120 of FIG. 1 modifies one or more messages exchanged by the endpoints to facilitate the codec type and/or encoding rate negotiations by, for example, adding session description protocol (SDP) information to the payload of one or more session initiation protocol (SIP) messages. An example data structure that may be used to implement a SIP message containing SDP information is discussed below in connection with FIG. 7. However, any number and/or type(s) of method(s), technique(s) and/or protocol(s) may be used to implement codec type and/or encoding rate negotiations based on data rate capabilities of endpoints. For example, the call processing system(s) 120 provide information to one or both of the endpoints about the data rate capability of the other endpoint. One or both of the endpoints may then use the data rate capability(-ies) to perform codec type and/or encoding rate negotiations by, for example, including SDP information in payloads of transmitter SIP messages.

Persons of ordinary skill in the art will readily recognize that the call processing system(s) 120 may, additionally or alternatively, cause any portion of a communication session to be established at one data rate while another portion is established at a different rate. Consider an example telephone call from a PSTN based telephone (not shown) to a VoIP endpoint (e.g., one of the example devices 105-108), the example call processing system 120 transmits and receives the PSTN portion of the call from the PSTN 135 at an encoding data rate of 64 kbps, and establishes the VoIP portion of the call to the VoIP endpoint at a higher data rate, such as 192 kbps. The call processing system 120 performs any necessary transcoding (e.g., decoding and encoding) of data as it passes both directions between the telephone and the VoIP endpoint.

To store and/or record data rate capabilities for VoIP endpoints (e.g., the example VoIP devices 105-108), the example VoIP communication network 115 of FIG. 1 includes a profile database 145. For each endpoint supported by the example call processing system(s) 120, the example profile database 145 of FIG. 1 includes one or more values representative of data rate capabilities for the VoIP endpoint. In general, the profile database 145 contains at least the current connection speed of a given VoIP endpoint to the IP network 140. In some examples, the profile database 145 may contain one or more additional values that represent achievable throughput capabilities for the VoIP endpoint. Such additional values may, for example, represent actual sustained transfer data rates between the VoIP endpoint and the IP network 140, and/or the VoIP endpoint and the VoIP network 115 as a function of time-of-day, day-of-week and/or day-of-year. For example, a VoIP endpoint may have a nominal connection speed of 6 million bits per second (Mbps). However, during evening hours when the IP network 140 is more congested, the VoIP endpoint may only be able to achieve a sustained transfer data rate of 256 kbps with the VoIP network 115. Such sustainable data rate capability information may be obtained, for example, from any or all of the example monitor modules 110 and used to update data rate capability information stored in the profile database 145.

The example profile database 145 may be implemented using any number and/or type(s) of data structures, such as a line information database (LIDB) and/or in accordance with a home subscriber server (HSS) database. An example data structure that may be used to implement the example profile database 145 of FIG. 1 is described in connection with FIG. 5. In the illustrated example of FIG. 1, the data structure 145 is stored in any number and/or type(s) of data storage device(s) and/or memory(-ies) 150.

While one profile database 145 is illustrated in FIG. 1, persons of ordinary skill in the art will readily appreciate that there may be any number and/or type(s) of profile databases 145 that may be distributed and/or shared amongst one or more call processing system(s) 120 and/or one or more VoIP networks 115.

While an example VoIP communication network 115 has been illustrated in FIG. 1, the devices, networks, systems, and/or processors illustrated in FIG. 1 may be combined, divided, re-arranged, eliminated and/or implemented in any of a variety of ways. Further, any or all of the example VoIP devices 105-108, the example monitor modules 110, the example call processing system(s) 120 and/or, more generally, the example VoIP communication network 115 of FIG. 1 may be implemented by hardware, software, firmware and/or any combination of hardware, software and/or firmware. Moreover, the example VoIP communication network 115 may include additional servers, systems, networks, gateways, portals, and/or processors than those illustrated in FIG. 1 and/or may include more than one of any or all of the illustrated devices, servers, networks, systems, gateways, portals, and/or processors.

FIG. 2 illustrates an example manner of implementing any or all of the example VoIP devices 105-108 of FIG. 1. While any of the example VoIP devices 105-108 may be represented by FIG. 2, for ease of discussion, the example device of FIG. 2 will be referred to as VoIP device 105. To handle VoIP processing functions, the example VoIP device 105 of FIG. 2 includes any number and/or type(s) of VoIP processors 210. The example VoIP processor 210 of FIG. 2 implements, among other things, session control, VoIP protocols, a SIP user agent, and a coder (not shown) to encode audio and/or video signals, a decoder (not shown) to decode received audio and/or video signals, a packetizer (not shown) to packetize encoded data and a de-packetizer (not shown) to de-packetize encoded data.

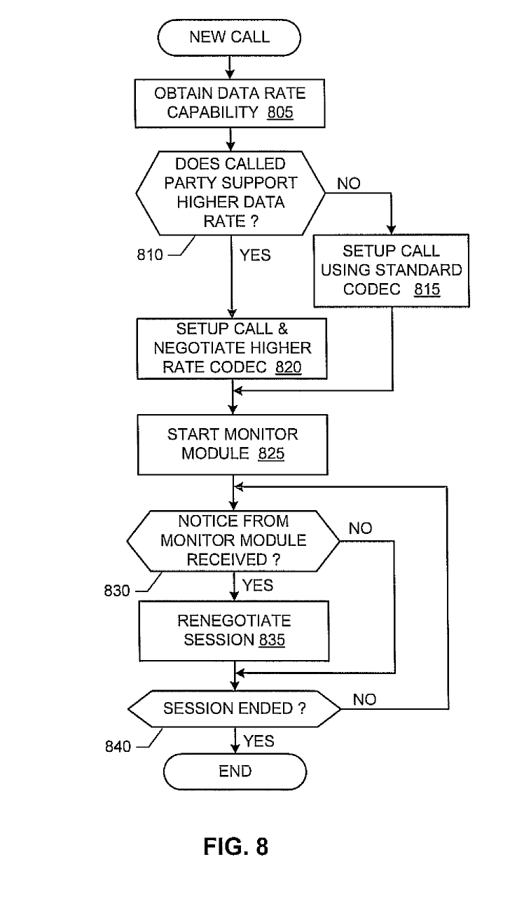

In addition to any number and/or type(s) of specialized hardware, firmware and/or logic to perform VoIP processing functions, the example VoIP processor 210 of FIG. 2 may include any number and/or type(s) of specialized and/or general purpose controller(s) and/or processing unit(s) capable of executing coded instructions. For example, the controller and/or processing unit may perform any number and/or type(s) of VoIP processing functions by carrying out and/or executing coded instructions 215 and/or 217 present in a main memory of the VoIP processor 210 (e.g., within a random-access memory (RAM) 220 and/or a read-only memory (ROM) 225). For example, all or some of the coded instructions 215 and/or 217 may be executed to implement the example monitor module 110 of FIGS. 1 and/or 4, and/or the example machine accessible instructions discussed below in connection with FIGS. 8 and/or 9. Additionally or alternatively, any or all of the example monitor module 110 of FIGS. 1 and/or 4, and/or the example machine accessible instructions of FIGS. 8 and/or 9 may be implemented as hardware, software firmware and/or logic and/or any combination(s) of hardware, software, firmware and/or logic within the VoIP processor 210 and/or, more generally, within the example VoIP device 105 of FIG. 2.

The example VoIP processor 210 is in communication with the main memory (including a read-only memory (ROM) 225 and/or the RAM 220) and other devices and/or modules of the example VoIP device 105 of FIG. 2 via any type(s) and/or number of buses 230. The example RAM 220 may be implemented by, for example, dynamic random-access memory (DRAM), synchronous dynamic random-access memory (SDRAM), and/or any other type of RAM device(s), and the example ROM 225 may be implemented by, for example, flash memory(-ies) and/or any other desired type of memory device(s). Access to the example memory 220 and 225 is typically controlled by a memory controller (not shown).

To store codec configuration data, the example VoIP device 105 of FIG. 2 includes a codec configuration data store 218. The example codec configuration data store 218 of FIG. 2 stores one or more codec configuration parameters (e.g., sampling rates, coefficients, etc.) for each type of codec and/or codec encoding rate supported and/or implemented by the example VoIP processor 210 and/or, more generally, the example VoIP device 105. The codec configuration data store 218 may be stored in any number and/or type(s) of memory device(s) such as a flash memory.

To electrically couple signals (e.g., speech signals) between handset 235 and the example VoIP processor 210, the example VoIP device 105 of FIG. 2 includes any number and/or type(s) of analog circuits 240. An example analog circuit 240 includes any number and/or type(s) of filter(s), analog-to-digital converter(s) and/or digital-to-analog converter(s) to convert between analog signals sent to and/or received from an example handset 235 and digital signals sent to and/or received from the example VoIP processor 210. The handset 235 can be corded or cordless.

To this end, the example analog circuit 240 of FIG. 2 may implement any number and/or type(s) of wireless communication technologies to communicatively couple the example VoIP processor 210 with any type of cordless handset 235. Moreover, the example analog circuit 240 of FIG. 2 may, additionally or alternatively, implement any number and/or type(s) of subscriber line interface circuits (SLICs) that allow any number and/or type(s) of corded and/or cordless PSTN-based telephones 245 to be electrically coupled to the example VoIP processor 210 of FIG. 2. The latter example could be used, for instance, in implementations where the example VoIP device 105 is located in and/or implements a VoIP analog telephone adapter and/or residential gateway.

To facilitate user inputs via any type of keypad 250, the example VoIP device 105 of FIG. 2 includes any type of keypad interface 255. The example keypad interface 255 of FIG. 2 electrically couples and/or translates electrical signals conveying key press information from the example keypad 250 to the example VoIP processor 210.

To provide output information to a user via any number and/or type(s) of displays 260, the example VoIP device 105 of FIG. 2 includes any number and/or type(s) of display interfaces 265. An example display interface 265 receives information (e.g., alphanumeric characters) to be displayed from the example VoIP processor 210 and creates electrical signals suitable for displaying the information on the example display 260. An example display 260 is a liquid-crystal display (LCD) screen.

To communicatively couple the example VoIP device 105 to the example IP network 140 of FIG. 1, a local-area network (LAN), a modem, a router, a bridge and/or a gateway, the example VoIP device 105 includes any number and/or type(s) of network interfaces 270. The example network interface(s) 270 of FIG. 2 implement any number and/or type of communication and/or data interface(s) in accordance with any past, current and/or future standards such as Ethernet, DSL, WiMax, WiFi, cable modems, etc.

While an example VoIP device 105 is illustrated in FIG. 2, the VoIP device 105 may be implemented using any number and/or type(s) of other and/or additional processors, devices, components, circuits, modules, interfaces, etc. Further, the processors, devices, components, circuits, modules, elements, interfaces, etc. illustrated in FIG. 2 may be combined, divided, re-arranged, eliminated and/or implemented in any of a variety of ways. Additionally, any or all of the example VoIP device 105 may be implemented as any combination of firmware, software, logic and/or hardware. Moreover, the example VoIP device 105 may include additional processors, devices, components, circuits, interfaces and/or modules in addition to those illustrated in FIG. 2 and/or may include more than one of any or all of the illustrated processors, devices, components, circuits, interfaces and/or modules.

FIG. 3 illustrates an example manner of implementing any or all of the example call processing systems 120 of FIG. 1. The example system of FIG. 3 is commonly referred to as a “soft-switch” architecture in that a first server (e.g., a media gateway 305) implements the actual transmitting, receiving and/or transcoding of communication session data, while a second server (e.g., a media gateway controller (MGC) 310) implements the signaling, control, logic and/or protocol(s) to initiate, route and/or establish VoIP communication sessions.

To process and/or handle VoIP communication service data to, from and/or between any of the example VoIP devices 105-108, the PLMN 130 and/or the PSTN 135, the example call processing system 120 of FIG. 3 includes any number and/or type(s) of media gateways 305. Using any number and/or type(s) of technique(s), method(s) and/or algorithm(s), the media gateway 305 of FIG. 3 performs any necessary data conversion between the circuit-based format used by the PSTN 135 and a packet-based format used by the VoIP network 115, the IP network 140, and/or the VoIP devices 105-108. The media gateway 305 also routes communication session data amongst endpoints.

To control the media gateway 305, the example call processing system 120 of FIG. 3 includes any number and/or type(s) of media gateway controllers (MGC) 310. Using any number and/or type(s) of technique(s), method(s) and/or in accordance with any past, present and/or future specifications and/or standards such as, for example, Internet Engineering Task Force (IETF) Request for Comment (RFC) 3015 and/or the ITU-T H.248 standard, the example MGC 310 of FIG. 3 performs signaling, session control and/or session management for incoming and/or outgoing VoIP communication sessions. For instance, for a VoIP communication device initiating an outgoing telephone call, a SIP INVITE message is routed by the call processing system 120 and/or, more generally, the VoIP network 115 to an MGC 310 which, in turn, directs, routes and/or assists in establishing a communication path and/or communication session (e.g., a telephone call) with a called device (i.e., a called party). Likewise, a VoIP communication device receiving an incoming communication session receives a SIP INVITE message via the MGC 310. The example MGC 310 of FIG. 3 maintains session state for each current subscriber and/or communication session, and enables communication with application servers, feature servers and/or content servers to provide any number and/or type(s) of features and/or applications such as, for example, parallel ringing, voice mail, unified messaging, etc.

When the example MGC 310 of FIG. 3 is processing a new incoming and/or outgoing communication session, the MGC 310 determines the data rate capability of either or both of endpoints of the VoIP communication session (e.g., one of the VoIP devices 105-108). If the originator and/or the destination endpoints are currently connected to the IP network 140 such that one or both of them can support high data rate communication services (e.g., expanded VoIP telephone services implementing codec encoding bit rates of greater than 128 kbps), the example MGC 310 initiates and/or facilitates the negotiation of a codec type and/or encoding bit rate commensurate with the high data rate capability of the endpoint(s). As such, when two VoIP endpoints of a VoIP communication session support high data rate communications, the MGC 310 causes the VoIP communication session to be established at a high data rate, thereby improving the audio and/or video fidelity of the ensuing VoIP communication session.

In the illustrated example, the MGC 310 of FIG. 3 modifies one or more messages exchanged by the endpoints to facilitate the codec type and/or encoding rate negotiations by, for example, adding SDP information to the payload of SIP messages. An example data structure that may be used to implement a SIP message containing SDP information is discussed below in connection with FIG. 7. However, any number and/or type(s) of method(s), technique(s) and/or protocol(s) may be used to implement codec type and/or encoding rate negotiations based on data rate capabilities of endpoints. For example, the MGC 310 could provide information to one or both of the endpoints about the data rate capability of the other endpoint. One or both of the endpoints may then use the data rate capability(-ies) to perform codec type and/or encoding rate negotiations by, for example, including SDP information in payloads of transmitted SIP messages.

The example MGC 310 of FIG. 3 can also initiate and/or perform codec type and/or encoding data rate re-negotiation(s) for an ongoing communication session. For example, if a monitor module 110 determines that that the quality of the communication session has fallen below a threshold, the MGC 310 can send one or more SIP messages that contain SDP information to cause one or both of the endpoints to re-negotiate the codec type and/or encoding data rate to be used for the communication session. The example MGC 310 of FIG. 3 can also used a time-of-day, day-of-week and/or day-of-year variable to determine when to initiate codec type and/or encoding data rate renegotiations. For example, the MGC 310 may restrict VoIP communication sessions to relatively lower data rates during periods of time when the VoIP network 115 and/or IP network 140 have historically (e.g., evenings, holidays, etc.) had higher utilizations and/or loadings.

To manage subscriber information and/or to enable subscribers and/or servers to locate destinations, the example call processing system 120 of FIG. 3 includes any number and/or type(s) of home subscriber server(s) 320. The example HSS 320 of FIG. 3 maintains a profile and/or set of preference variables for each subscriber of the call processing system 120 and/or, more generally, the example VoIP network 115 that implements the call processing system 120.

As discussed above in connection with FIG. 1, the example HSS 320 of FIG. 3 may also be used to implement all or any portion of the example profile database 145. For example, the data rate capability(-ies) of a particular VoIP endpoint may be stored together with the profile and/or set of preference variables maintained for the VoIP endpoint by the example HSS 320.

To monitor the quality of an ongoing communication session, the example call processing system 120 of FIG. 3 includes one or more monitor modules 110. The example monitor module 110 of FIG. 3 monitors one or more parameters and/or values that represent the quality of a communication sessions. Example parameters and/or values that may be monitored are a bandwidth, a quality-of-service, a delay, a jitter, or a packet loss rate. If the quality of a particular communication session degrades (e.g., a value representative of the quality falls below a threshold), the example monitor module 110 of FIG. 3 can notify the MGC 310 that it needs to initiate either the re-negotiation of a new codec type, and/or a change in the encoding bit rate of the current codec type. The MGC 310 may also be notified by the monitor module 110 when the quality of a communication session improves (e.g., a wireless VoIP device is now connected to the IP network 140 at a higher speed). The MGC 310 may then initiate either the re-negotiation of a new codec type and encoding bit rate, or a change in the encoding bit rate of the codec type currently being employed to implement a higher data rate communication session. An example manner of implementing the example monitor modules 110 of FIG. 3 is discussed below in connection with FIG. 4.

It will be readily appreciated by persons of ordinary skill in the art that the example monitor module 110, the example media gateway 305, the example MGC 310, and the example HSS 320 illustrated in FIG. 3 are logical entities in call processing systems 120 and/or VoIP networks 115. They may be implemented, for example, as machine accessible instructions executed by one or more computing devices and/or computing platforms. Further, while an example call processing system 120 has been illustrated in FIG. 3, the example logical entities of the call processing system 120 may be combined, divided, re-arranged, eliminated and/or implemented in any of a variety of ways. Further still, the monitor module 110, the example media gateway 305, the example MGC 310, the example HSS 320 and/or, more generally, the example call processing system 120 may be implemented by hardware, software, firmware and/or any combination of hardware, software and/or firmware. Moreover, call processing system 120 and/or, more generally, a VoIP network 115 may include additional logical entities than those illustrated in FIG. 3 and/or may include more than one of any of the illustrated logical entities.

FIG. 4 illustrates an example manner of implementing any or all of the example monitor modules 110 of FIGS. 1, 2 and/or 3. To monitor the quality of an ongoing communication session, the example monitor module 110 of FIG. 4 includes a quality analyzer 405. Using any number and/or type(s) of algorithm(s), method(s), variable(s), data and/or logic, the example quality analyzer 405 of FIG. 4 monitors one or more parameters and/or values that represent the quality of a communication sessions. Example parameters and/or values are a bandwidth, a quality-of-service, a delay, a jitter, and/or a packet loss rate.

To implement session re-negotiation decisions, the example monitor module 110 of FIG. 4 includes monitoring logic 410. The example monitoring logic 410 of FIG. 4 compares one or more parameters and/or values that represent the quality of a communication session with one or more predetermined thresholds to determine whether or not the quality of the communication session has degraded and requires re-negotiation of a codec type and/or encoding data rate. The example monitoring logic 410 can also monitor the quality of the communication session to determine when a higher data rate communication session could be implemented.

To initiate codec type and/or encoding data rate re-negotiations, the example monitor module 110 of FIG. 4 includes a service adjuster 415. When the monitoring logic 410 determines that the quality of a communication session has degraded and/or improved, the example service adjuster 415 of FIG. 4 notifies a VoIP processor (e.g., the example VoIP processor 210 of FIG. 3) and/or a MGC (e.g., the example MGC 310 of FIG. 3) that the codec type and/or encoding data rate may need to be re-negotiated for the communication session. Additionally or alternatively, all or a portion of the service adjuster 415 may be implemented by a MGC and/or a VoIP processor (e.g., the example processor 210 of FIG. 2).

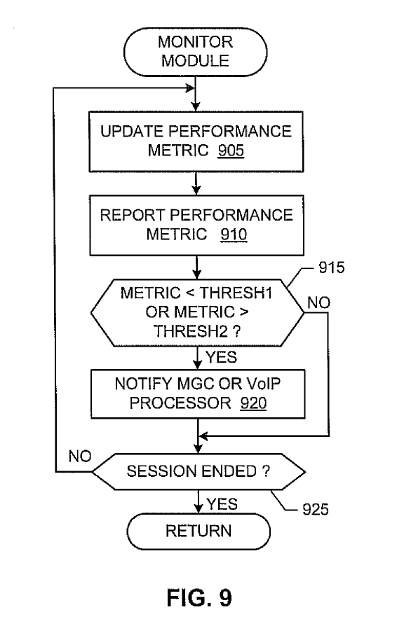

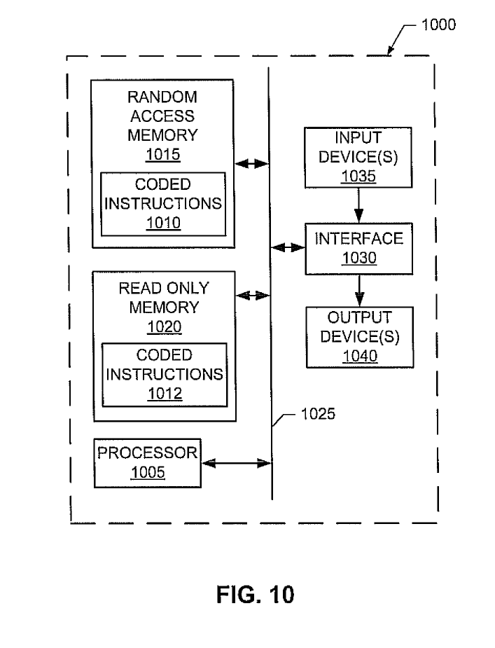

While an example monitor module 110 is illustrated in FIG. 4, the example monitor module 110 may be implemented using any number and/or type(s) of other and/or additional processors, devices, components, circuits, modules, interfaces, etc. Further, the processors, devices, components, circuits, modules, elements, interfaces, etc. illustrated in FIG. 4 may be combined, divided re-arranged, eliminated and/or implemented in any of a variety of ways. Additionally, the example monitor module 110 may be implemented as any combination of firmware, software, logic and/or hardware. For example, the example monitor module 110 may be implemented as coded instructions (e.g., the example coded instructions 215 and/or 217 of FIG. 2, and/or the example coded instructions 1010 and/or 1012 of FIG. 9) executed by, for example, the example VoIP processor 210 of FIG. 2 and/or the example processor 1005 of FIG. 10. Moreover, the example monitor module 110 may include additional processors, devices, components, circuits, interfaces and/or modules than those illustrated in FIG. 4 and/or may include more than one of any or all of the illustrated processors, devices, components, circuits, interfaces and/or modules.

FIG. 5 illustrates an example data structure that may be used to implement the example profile database 145 and/or the example HSS 320 of FIGS. 1 and 3. The example data structure of FIG. 5 contains a plurality of entries 505 for respective ones of a plurality of communication session endpoints (e.g., the example VoIP devices 105-108). To identify the endpoint, each of the entries 505 of FIG. 5 includes a destination identification field 510. The example destination identification field of FIG. 5 contains a value and/or string that uniquely identifies the corresponding endpoint, such as a SIP uniform resource identifier (URI) (e.g., SIP: new_service_testor@voip.att.com) or a telephone number URI (e.g., a 10-digit telephone number).

To specify data rate capabilities for a plurality of time-of-day, day-of-week and/or day-of-year periods, each of the example entries 505 of FIG. 5 includes respective ones of a plurality of data rate capability fields 515. Each of the data rate capability fields 515 of FIG. 5 contains a value that represents a data rate capability (e.g., 6 Mbps, 1 Mbps, 128 kbps, etc.) for the corresponding VoIP endpoint for a corresponding time-of-day, day-of-week and/or day-of-year period of time.

While an example data structure is illustrated in FIG. 5, the example data structure may be implemented using any number and/or type(s) of other and/or additional fields and/or data. Further, the fields and/or data illustrated in FIG. 5 may be combined, divided, re-arranged, eliminated and/or implemented in any of a variety of ways. Moreover, the example data structure may include additional fields and/or data than those illustrated in FIG. 5 and/or may include more than one of any or all of the illustrated fields and/or data. For example, additional fields may be present that contain preference and/or profile information for the corresponding endpoint.

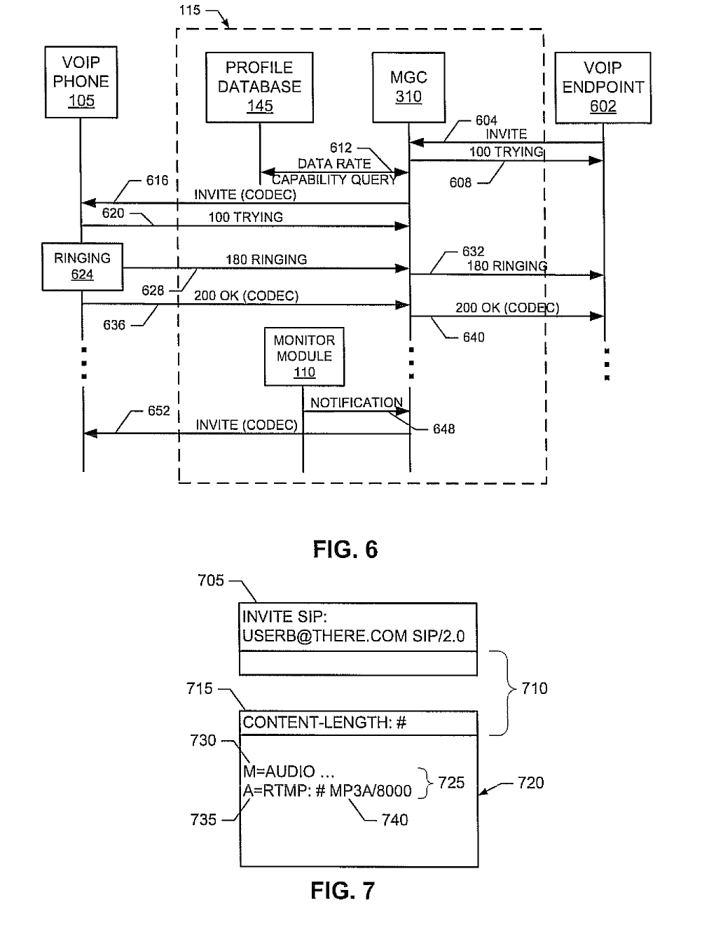

FIG. 6 diagrammatically illustrates example behaviors of the example VoIP communication system of FIG. 1. The example of FIG. 6 illustrates the establishment and monitoring of a VoIP communication session. While the establishment of a VoIP telephone call is illustrated in FIG. 6, persons of ordinary skill in the art will readily appreciate that the example behaviors illustrated in FIG. 6 may be applied to the establishment of other types of communication sessions (e.g., a session between a VoIP endpoint and a PSTN telephone, a video session, etc.).

The illustrated example of FIG. 6 begins with receipt of an incoming SIP INVITE message 604 from a VoIP calling endpoint 602. The example SIP INVITE message 604 of FIG. 1 is directed to the example VoIP phone 105. In the illustrated example, the SIP INVITE message 604 is received at an MGC 310. In response to the incoming call initiation 604, the example MGC 310 of FIG. 6 responds with a SIP 100 TRYING message 608 and queries the profile database 145 to obtain an applicable data rate capability for the VoIP phone 105 as illustrated with reference number 612.

Based upon the obtained data rate capability of the VoIP phone 105, the example MGC 310 of FIG. 6 modifies the INVITE message 604 to add and/or modify codec negotiation information. For example, if the VoIP phone 105 has a high data connection to the IP network 140, the MGC 310 modifies and/or adds SDP information to the payload of the INVITE message 604 that identifies a higher data rate codec type and/or an encoding data rate. The example MGC 310 selects the codec type and/or encoding data rate from a list of codec types and/or encoding data rates supported by the VoIP phone 105 and/or the calling VoIP endpoint 602. The MGC 310 sends the modified version 616 of the INVITE message 604 to the VoIP phone 105.

The VoIP Phone 105 responds to the SIP INVITE message 616 with a SIP 100 TRYING response message 620. When the VoIP phone 105 starts ringing 624, it sends a SIP 180 RINGING message 628 to the MGC 310. The MGC 310 then sends a corresponding 180 RINGING message 632 to the calling endpoint 602.

When the VoIP phone 105 is picked up (i.e., the incoming called party answers), the VoIP phone 105 sends a SIP 200 OK message 636 that contains codec negotiation and/or confirmation information. For example, the VoIP phone 105 can include SDP information in the payload of the 200 OK message 636 that confirms the usage and/or selection of a higher data rate codec type and/or encoding data rate indicated by the MGC 310 in the INVITE message 616. The MGC 310 then sends a corresponding 200 OK message 640 to the calling endpoint 602 that includes the codec negotiation information from the 200 OK message 636 thereby allowing the communication session to be established at a higher data rate.

Once the communication session is established, a monitor module 110 begins monitoring the quality of the communication session. If the example monitor module 110 of FIG. 6 determines that the quality of the communication session has improved and/or degraded such that a codec type and/or encoding data rate re-negotiation may be necessary and/or beneficial, the monitor module 110 notifies the MGC 310 of the change as illustrated in FIG. 6 with reference numeral 648. Upon receipt of the notification 648, the example MGC 310 of FIG. 6 initiates the re-negotiation of the codec type and/or encoding data rate for the communication session by, for example, sending an INVITE message 652 that contains a different codec type and/or encoding data rate from that sent in the example INVITE message 616. Persons of ordinary skill in the art will readily appreciate that the VoIP phone 105 and the calling endpoint 602 then complete the re-negotiation of the communication session (not shown).

Persons of ordinary skill in the art will readily appreciate that the example VoIP calling endpoint 602 could also query the profile database 145 to obtain the data rate capability information for the VoIP phone 105 and then perform the codec type and/or encoding data rate negotiation without a MGC 310 having to add SDP information to the payload of the SIP INVITE message 616. For example, the VoIP endpoint 602 could add SDP information to the payload of the SIP INVITE message 604 that specifies a higher data rate codec type and/or encoding data rate.

FIG. 7 illustrates an example data structure that may be used to implement a SIP message that contains SDP information. To identify the SIP message, the example data structure of FIG. 7 includes a name field 705. The example name field 705 of FIG. 7 includes an alphanumeric string that identifies the SIP message and identifies a destination for the example message. The example SIP message illustrated in FIG. 7 is a SIP INVITE message and, thus, the example name field 705 contains a string that includes “INVITE”. In the illustrated example, the SIP message is addressed to userb@there.com. Persons of ordinary skill in the art will readily recognize that the name field 705 could be used to identify any type of SIP message to any applicable destination.

To provide additional values and/or parameters, the example data structure of FIG. 7 includes one or more header fields 710. Example header fields 710 include, but are not limited to, a from field, a caller identification field, a command sequence number field, and/or a length field 715. The number of header fields 710, in some examples, depends upon the type of SIP message and/or the protocol(s) implemented by either endpoint. The example length field 715 of FIG. 7 contains a value that represents the length (possibly zero) of a payload 720 of the data structure. The example payload 720 of FIG. 7 may be used to carry any number and/or type(s) of information applicable to a particular SIP message.

To convey session negotiation information, the example payload 720 of FIG. 7 includes SDP information 725. The example SDP information 725 of FIG. 7 describes and/or specifies one or more possible parameters of a communication session being initiated and/or modified. The example SDP information 725 of FIG. 7 includes one or more media information fields 730 and one or more attribute fields 735. The example media information field 730 of FIG. 7 specifies an audio session (e.g., for a telephone call). The example attribute field 735 of FIG. 7 specifies an MPEG-3 audio codec 740 with a sampling rate of 8000 cycles per second (Hz). Persons of ordinary skill in the art will readily recognize that the SDP information 725 could specify additional sessions and/or attributes. For example, the SDP information 725 could specify more than one possible audio session that could be used for a VoIP telephone call. Each possible audio session may specify a different codec type and/or encoding data rate, thus, allowing a receiver of the message to select a compatible codec type and/or encoding data rate.

While an example data structure is illustrated in FIG. 7, the example data structure may be implemented using any number and/or type(s) of other and/or additional fields and/or data. Further, the fields and/or data illustrated in FIG. 7 may be combined, divided, re-arranged, eliminated and/or implemented in any of a variety of ways. Moreover, the example data structure may include additional fields and/or data than those illustrated in FIG. 7 and/or may include more than one of any or all of the illustrated fields and/or data.

FIGS. 8 and 9 are flowcharts representative of example machine accessible instructions that may be executed to implement the example VoIP devices 105-108, the example call processing system 115, the example VoIP processor 210, the example MGC 310, and/or the example monitor modules 110 of FIGS. 1-4. The example machine accessible instructions of FIGS. 8 and/or 9 may be executed by a processor, a controller and/or any other suitable processing device. For example, the example machine accessible instructions of FIG. 8 and/or 9 may be embodied in coded instructions stored on a tangible medium such as a flash memory, a ROM and/or RAM associated with a processor (e.g., the example processor 210 discussed above in connection with FIG. 2 and/or the example processor 1005 discussed below in connection with FIG. 10). Alternatively, some or all of the example flowcharts of FIGS. 8 and/or 9 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example flowcharts of FIGS. 8 and/or 9 may be implemented manually or as any combination(s) of any of the foregoing techniques, for example, any combination of firmware, software, discrete logic and/or hardware. Further, although the example machine accessible instructions of FIGS. 8 and 9 are described with reference to the flowcharts of FIGS. 8 and 9 persons of ordinary skill in the art will readily appreciate that many other methods of implementing the example VoIP devices 105-108, the example call processing system 115, the example VoIP processor 210, the example MGC 310, and/or the example monitor modules 110 may be employed. For example, the order of execution of the blocks may be changed, and/or some of the blocks described may be changed, eliminated, sub-divided, or combined. Additionally, persons of ordinary skill in the art will appreciate that the example machine accessible instructions of FIG. 8 and/or 9 may be carried out sequentially and/or carried out in parallel by, for example, separate processing threads, processors, devices, discrete logic, circuits, etc.

The example machine readable instructions of FIG. 8 begin when an MGC (e.g., the example MGC 310 of FIG. 3) receives an INVITE message for a new session and/or a VoIP device (e.g., any of the example VoIP devices 105-108 of FIG. 1) initiates a new communication session. The MGC and/or the VoIP device obtains the data rate capability for the called party (block 805). For example, the MGC and/or the VoIP device queries a profile database (e.g., the example profile database 145 of FIG. 1) to obtain the data rate capability. In some examples, the MGC and/or the VoIP device performs the query based on a time-of-day, a day-of-week and/or a day-of-year.

If the called party has a data rate capability that does not support a higher data rate communication session (block 810), the MGC and/or the VoIP device establishes the call using a standard and/or default codec type and/or encoding data rate (block 815). Control then proceeds to block 825 to start a monitor module.

If the called party has a data rate capability that supports a higher data rate communication session (block 810), the MGC and/or the VoIP device establishes the call using a higher data rate codec type and/or encoding data rate (block 820). For example, an MGC may modify a received INVITE message to add and/or modify SDP information, or a VoIP device may add SDP information to an INVITE message that will be sent.

At block 825, the MGC and/or calling VoIP device starts a monitor module (e.g. any of the example monitor modules 110 of FIGS. 1, 2, 3 and/or 4) to monitor the quality of the established communication session by, for example, initiating execution of the example machine accessible instructions of FIG. 9 (block 825).

The MGC and/or the calling and/or called VoIP device then checks for a notice from the monitor module (block 830). If a notice is received the MGC and/or the VoIP device initiates the re-negotiation of a codec type and/or encoding data rate for the communication session (block 835). The session may be re-negotiated to a higher or lower data rate depending upon the notification received from the monitor module. If a notice has not been received, control proceeds to block 840 to determine if the session has ended without re-negotiating a codec type and/or encoding data rate.

At block 840, the MGC and/or the calling and/or called VoIP device determines if the communication session has ended (block 840). If the communication session has not ended (block 840), control returns to block 830 to check for a notification from the monitor module. If the communication session has ended, control exists from the example machine accessible instructions of FIG. 8.

The example machine accessible instructions of FIG. 9 begin with a monitor module (e.g., any of the example monitor modules 110 of FIGS. 1-4) updating one or more metrics (e.g., values or parameters) that represents the current performance and/or quality of a communication session (block 905). In some examples, the monitor module reports the update performance metric to a VoIP network 115, a call processing system 120, a profile database 145 and/or an MGC 310 so that the data rate capability of a VoIP endpoint may be updated (block 910).

If one or more of the metrics indicate that the quality of a monitored communication session has degraded (e.g., the metric is less than a first threshold) and/or improved (e.g., the metric is greater than a second threshold) (block 915), the monitor module notifies an associated MGC or VoIP processor of the change (block 920).

If the metric does not indicate a change in quality (block 915), control proceeds to block 925 without notifying an MGC or VoIP processor.

At block 925, the monitor module determines if the communication session has ended (block 925). If the communication session has not ended (block 925), control returns to block 905 to update the performance metric(s). If the communication session has ended, control exists from the example machine accessible instructions of FIG. 9.

FIG. 10 is a schematic diagram of an example processor platform 1000 that may be used and/or programmed to implement all or a portion of the example VoIP devices 105-108, the example call processing system 115, the example VoIP processor 210, the example MGC 310, and/or the example monitor modules 110. For example, the processor platform 1000 can be implemented by one or more general purpose processors, processor cores, microcontrollers, etc.

The processor platform 1000 of the example of FIG. 10 includes at least one general purpose programmable processor 1005. The processor 1005 executes coded instructions 1010 and/or 1012 present in main memory of the processor 1005 (e.g., within a RAM 1015 and/or a ROM 1020). The processor 1005 may be any type of processing unit, such as a processor core, a processor and/or a microcontroller. The processor 1005 may execute, among other things, the example machine accessible instructions of FIGS. 5 and/or 6 to perform network message processing. The processor 1005 is in communication with the main memory (including a ROM 1020 and/or the RAM 1015) via a bus 1025. The RAM 1015 may be implemented by DRAM, SDRAM, and/or any other type of RAM device, and ROM may be implemented by flash memory and/or any other desired type of memory device. Access to the memory 1015 and 1020 maybe controlled by a memory controller (not shown). The RAM 1015 may be used to store and/or implement, for example, the example codec configuration data 218 or the example profile database 145.

The processor platform 1000 also includes an interface circuit 1030. The interface circuit 1030 may be implemented by any type of interface standard, such as an external memory interface, serial port, general purpose input/output, etc. One or more input devices 1035 and one or more output devices 1040 are connected to the interface circuit 1030. The input devices 1035 and/or output devices 1040 may be used to, for example, the keypad interface 255, the display interface 265, the network interface 270 of FIG. 2 and/or one or more interfaces between a monitor module 110 and an MGC 310, or between an MGC 310 and a profile database 145.

Of course, persons of ordinary skill in the art will recognize that the order, size, and proportions of the memory illustrated in the example systems may vary. Additionally, although this patent discloses example systems including, among other components, software or firmware executed on hardware, it will be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method comprising:
retrieving a data rate capability associated with a destination of a voice over Internet protocol (VoIP) session from a customer database;
selecting between a first codec having a first bit rate and a second codec having a second bit rate different from the first bit rate based on the retrieved data rate capability; and
establishing the VoIP session based on a selected one of the first and second codecs.

2. A method as defined in claim 1, wherein the second bit rate is lower than the first bit rate, and selecting between the first codec and the second codec based on the retrieved data rate capability comprises:
determining whether the destination supports an expanded bit rate VoIP session; and
selecting the first codec when the destination supports the expanded bit rate VoIP session.

3. (canceled)

4. (canceled)

5. A method as defined in claim 2, further comprising selecting the second codec when the destination does not support the expanded bit rate VoIP session.

6. A method as defined in claim 2, further comprising:
monitoring a value that represents a quality of the VoIP session; and
modifying the VoIP session to utilize the second codec when the value falls below a predetermined threshold.

7. A method as defined in claim 6, further comprising updating the data rate capability based on the value.

8. (canceled)

9. (canceled)

10. (canceled)

11. A method as defined in claim 1, wherein establishing the VoIP session based on the selected one of the first and second codecs comprises:
receiving a first VoIP protocol message from an initiator of the VoIP session;
modifying the first message based on the selected one of the first and second codecs; and
sending the modified first message to the destination.

12. A method as defined in claim 11, wherein the first message comprises a session initiation protocol (SIP) INVITE message, and modifying the first message comprises adding session description protocol (SDP) information to the INVITE message.

13. A method as defined in claim 1, wherein establishing the VoIP session based on the selected one of the first and second codecs comprises:
creating a first VoIP protocol message based on the selected one of the first and second codecs; and
sending the first message to the destination.

14. A method as defined in claim 13, wherein the first message comprises a session initiation protocol (SIP) INVITE message, and the selected one of the first and second codecs is specified in session description protocol (SDP) information included in the SIP INVITE message.

15. A method as defined in claim 1, further comprising:
determining a time of day; and
retrieving a data rate capability based on the time of day.

16. (canceled)

17. A method as defined in claim 1, wherein the destination is at least one of a VoIP phone, a VoIP residential gateway, a personal computer, a VoIP endpoint or a VoIP adapter.

18. For a voice over Internet protocol (VoIP) network having a plurality of VoIP destinations, an apparatus comprising:
a memory to store a data structure, the data structure having a first portion representative of a first data rate capability for a first VoIP destination, and a second portion representative of a second data rate capability for a second VoIP destination; and
a processor to select a codec for a VoIP session to the first VoIP destination based on the first data rate capability.

19. An apparatus as defined in claim 18, wherein the processor is configured to select the codec when the first data rate capability exceeds a threshold.

20. An apparatus as defined in claim 18, further comprising a monitor module to monitor a value that represents a quality of the VoIP session, and to modify the VoIP session to utilize a lower bit rate codec when the value falls below a predetermined threshold.

21. An apparatus as defined in claim 18, further comprising a monitor module to monitor a value that represents a quality of the VoIP session, and to modify the VoIP session to utilize a higher bit rate codec when the value rises above a predetermined threshold.

22. (canceled)

23. (canceled)

24. An apparatus as defined in claim 18, wherein the processor is configured to:
receive a first VoIP protocol message from an initiator of the VoIP session;
modify the first message based on the selected codec; and
send the modified first message to the destination.

25. An apparatus as defined in claim 24, wherein the first message comprises a session initiation protocol (SIP) INVITE message, and modifying the first message comprises adding session description protocol (SDP) information to the INVITE message.

26. An apparatus as defined in claim 18, wherein the processor is configured to:
create a first VoIP protocol message based on the selected codec; and
sending the first message to the destination.

27. An apparatus as defined in claim 26, wherein the first message comprises a session initiation protocol (SIP) INVITE message, and the selected codec is specified in session description protocol (SDP) information included in the SIP INVITE message.

28. An apparatus as defined in claim 18, wherein the processor is associated with an initiator of the VoIP session.

29. An apparatus as defined in claim 18, wherein the processor is associated with at least one of a media gateway controller, a call session controller, a session border controller, a soft-switch, or a call processor.

30. An apparatus as defined in claim 18, wherein the data structure is at least one of a line information database or a home subscriber server database.

31. An apparatus as defined in claim 18, wherein the data structure has a third portion representative of a call session controller for the first VoIP destination.

32. An apparatus as defined in claim 18, wherein the destination is at least one of a VoIP phone, a VoIP residential gateway, a personal computer, a VoIP endpoint or a VoIP adapter.

33. An article of manufacture storing machine readable instructions which, when executed, cause a machine to:
retrieve a data rate capability associated with a destination of a voice over Internet protocol (VoIP) session from a customer database;
select between a first codec having a first bit rate and a second codec having a second bit rate different from the first bit rate based on the retrieved data rate capability; and
establish the VoIP session based on a selected one of the first and second codecs.

34. An article of manufacture as defined in claim 33, wherein the second bit rate is lower than the first bit rate, and wherein the machine readable instructions, when executed, cause the machine to select between the first codec and the second codec based on the retrieved data rate capability by:
determining whether the destination supports an expanded bit rate VoIP session; and
selecting the first codec when the destination supports the expanded bit rate VoIP session.

35. An article of manufacture as defined in claim 34, wherein the second bit rate is lower than the first bit rate, and wherein the machine readable instructions, when executed, cause the machine to select the second codec when the destination does not support the expanded bit rate VoIP session.

36. An article of manufacture as defined in claim 34, wherein the machine readable instructions, when executed, cause the machine to:
monitor a value that represents a quality of the VoIP session; and
modify the VoIP session to utilize the second codec when the value falls below a predetermined threshold.

37. An article of manufacture as defined in claim 33, wherein the machine readable instructions, when executed, cause the machine to establish the VoIP session based on the selected one of the first and second codecs by:
receiving a first VoIP protocol message from an initiator of the VoIP session;
modifying the first message based on the selected one of the first and second codecs; and
sending the modified first message to the destination.

38. An article of manufacture as defined in claim 33, wherein the machine readable instructions, when executed, cause the machine to establish the VoIP session based on the selected one of the first and second codecs by:
creating a first VoIP protocol message based on the selected one of the first and second codecs; and
sending the first message to the destination.

39-46. (canceled)
